(19) United States
(12) Patent Application Publication
(10) Pub. No.: US 2017/0357921 A1
(43) Pub. Date: Dec. 14, 2017

(54) System, Method, and Apparatus for Prescreening Potential Tenants

(71) Applicant: Gary Glucroft, Chatsworth, CA (US)

(72) Inventor: Gary Glucroft, Chatsworth, CA (US)

(21) Appl. No.: 15/179,888

(22) Filed: Jun. 10, 2016

(51) Int. Cl. G06Q 10/06; G06Q 30/06

(52) U.S. Cl. CPC G06Q 10/0635; G06Q 30/0645

(57) ABSTRACT

A system, method, and apparatus for prescreening potential tenants is provided which mitigates risks and costs to landlords, property managers, and even potential tenants when potential tenants apply to rent real property. The prescreening system evaluates a potential tenant's personal information, such as credit score, income, and criminal background, against various prequalifying criteria to determine whether it is likely that the potential tenant will meet with approval in the later, often costly, application process. This ensures that a tenant may avoid paying multiple application fees, experiencing any negative results of multiple hard credit inquiries, as well as the hassle of scheduling time to walk-through properties they might later be denied rental of. Further, landlords and property managers may avoid spending time and resources showing property to and considering rental applications from potential tenants whose applications are not likely to be approved.

### GOVERNMENT CONTRACT

Not applicable.

### CROSS-REFERENCE TO RELATED APPLICATIONS

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to property rental, and more particularly to systems, methods, and apparatuses for prescreening potential real property tenants in a manner that saves landlords, property managers, and potential tenants time and money over traditional methods and further avoids negatively impacting a potential tenant's consumer credit report and score.

### BACKGROUND

Typical methods of renting property are frequently fraught with frustration for prospective tenants, landlords, and property managers alike. For instance, putative landlords must accept risks associated with tenants who may, over the course of their lease, fail to pay rent, damaging or steal their property, and even disturb other nearby tenants. The consequences of these risks may be costly for landlord who must him or herself pay the price of damages associated with such actions.

In an effort to mitigate these risks, various tenant screening procedures have been developed. For instance, many landlords and property managers require prospective tenants to consent to submit to criminal background and credit checks. These may indicate whether a tenant is likely to be able to reliably pay rent and utilities, whether they have a history of committing certain crimes, and even more specifically, a history of eviction. Additional human references may also be requested by a landlord to provide a more complete, personalized idea of the character of the potential tenant.

Unfortunately, these tenant screening procedures are imperfect and costly in terms of time and money. Many landlords and property managers pass the cost of conducting background and credit checks to the potential tenant in the form of so-called application fees. Because acceptance of a potential tenant is not guaranteed prior to these checks, many potential tenants apply to rent multiple properties in the event that their application is rejected for any single property. This undesirably increases a potential tenant's cost of finding housing.

Additionally, traditional tenant screening procedures are known to result in “hard” credit inquiries because the credit checks are performed by the landlord or property manager third-party, and not the tenant his or herself. These hard inquiries decrease an individual's credit score, which may be a problem for potential tenants who plan to seek other services that depend on their creditworthiness. Some tenants may be less inclined to apply to rent properties not knowing if their credit score or background will qualify them to rent, especially in consideration of the fact that many landlords and property managers recognize varying standards in accepting applications. As a result of the variance, it may be difficult for potential tenants to predict whether they will be qualified to rent individual properties, effectively encouraging them to pay associated application fees before assessing the likelihood of success. The same is true of move-in specials. Many tenants are unable to assess whether they qualify to take advantage of various perks, such as discounted deposits and first months' rent, until they pay an application fee and submit to the hard credit inquiry. Likewise, many potential tenants also schedule times to personally view the property they want to apply to rent prior to receiving any guarantee of eligibility. This is inefficient for both landlord or property manager and potential tenant, whose time may be better spent scheduling meetings for properties the potential tenants are guaranteed to qualify to rent.

Some solutions to enhance tenant screening procedures have been suggested. For instance, U.S. Pat. No. 7,987,207 to Peden teaches tenant screening enabled by an intermediate consumer information bureau; U.S. Pat. No. 7,881,982 to Pohl discloses a method, medium, and system by which potential tenants may pay to access real property listings, notify relevant parties of their interest in renting the property, and ensuring the relevant parties' regulatory compliance; U.S. Pat. No. 7,769,681 to Misraje et al. discloses a computer system and method for networked interchange of data and information for members of the real estate financial and related transactional services industry; U.S. Pub. No. 2002/0169641 filed by Wallace discloses a method of mitigating risks of accepting tenants by qualifying a renter against rent default using particularized standards for a third-party guarantor; and U.S. Pub. No 2004/0030649 filed by Nelson et al. discloses systems and methods for processing applications by validating information and requesting relevant data from a reporting bureau.

Still, none of the proposed solutions have sufficiently addressed the problems plaguing the process of applying to rent property. Thus, there remains a need for a system, method, and apparatus configured to prescreen potential tenants in a manner that avoids spending time and money on applications that are likely to be rejected.

### SUMMARY

The present disclosure is directed to a system, method, and apparatus for prescreening potential tenants. Elements of system, method, and apparatus are operable to mitigate risks and costs, especially time and money costs, to landlords, property managers, and even potential tenants when potential tenants apply to rent real property.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In an embodiment, the system for prescreening a potential tenant comprises an electronic device, such as a smart phone, laptop, tablet or even desktop computer, operative to evaluate a potential tenant's personal information against prequalification criteria provided by a landlord or property manager for a particular property, and alert each of the potential tenant and landlord and/or property manager to the likelihood that a potential tenant's rental application will be approved prior to paying for and submitting such application.

The system may be implemented as a mobile electronic device application. More particularly, the electronic device may be operative to receive a potential tenant's relevant personal information, such as credit score, income, criminal background, status of any delinquent utility debts, status of any landlord debt collections, and eviction history against various prequalifying criteria, such as acceptable consumer credit record—including score range—minimum income, and acceptable criminal history, among others, to determine whether it is likely that the potential tenant will meet with approval in the later, often costly, application process. In some embodiments such personal information may also be evaluated to determine if it is likely that a potential tenant may qualify for any move-in incentives that landlords and property managers sometimes offer to particularly attractive, or in other words, apparently low risk, potential tenants upon application to rent. This prescreening procedure may ensure that a tenant avoids paying multiple application fees for properties for which they otherwise have no guarantee of qualifying to rent. Further, landlords and property managers may avoid spending time and resources showing property to and considering rental applications from potential tenants whose applications are not likely to be approved.

To further minimize initial cost to the applicant, it is contemplated that the system may be configured to receive personal information that the tenant has procured himself. For instance, it is commonly known that credit checks result in hard inquiries that decrease one's credit score when such check is performed by a party other than the credit holder. Thus, an authorized credit check performed by a landlord to determine whether a potential tenant is likely to pay their rent will negatively affect the potential tenant's credit score. This may be particularly undesirable for potential tenants who plan to seek additional lines of credit, apply for jobs, or even seek new housing.

Thus, it is an object of the invention to minimize time and monetary costs of seeking housing.

It is another object of the invention to avoid consequences related to experiencing multiple hard credit inquiries close in time.

It is still another object of the invention to inform a potential tenant of available move-in specials they will qualify for in advance of applying to rent a particular property.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 is a blocked diagram of a networked environment in which an exemplary embodiment of a system for prescreening potential tenants is implemented.

FIG. 2 is a flowchart depicting an exemplary embodiment of a method for prescreening potential applicants that may be performed by the system drawn in FIG. 1.

FIG. 3 illustrates an exemplary embodiment of an electronic device shown in FIG. 1.

FIGS. 4A-C shows an exemplary user interface for the system and method for prescreening potential tenants in accordance with one embodiment.

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

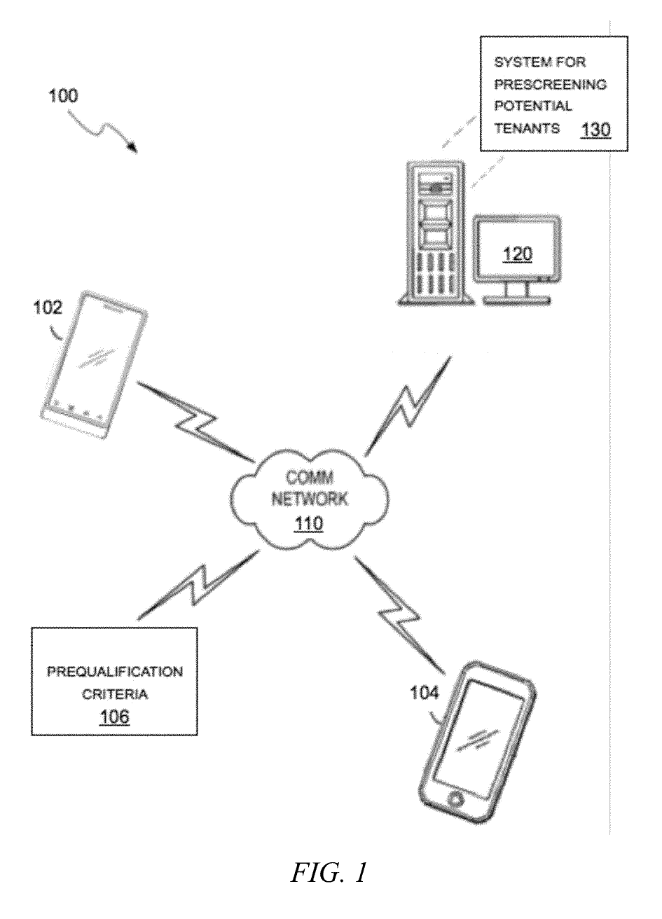

With reference to FIG. 1 a networked environment is shown in which an exemplary embodiment of a system for prescreening potential tenants is implemented. As shown in FIG. 1, system 100 may comprise a plurality of electronic devices. By way of example, and not limitation, two mobile electronic devices 102 and 104 are shown communicatively coupled via a communication network 110. Each of the electronic devices 102 and 104 may be embodied as a mobile computing device such as, for example and without limitation, a smartphone that incorporates cellular telephone functionality. Notably, the communications network can use one or more of various communications types such as, for example and without limitation, cellular and Wi-Fi communications.

Users of mobile devices 102 and 104 exchange information pertinent to a variety of prequalification criteria 106 provided by a landlord or property manager to define eligibility requirements to rent a particular property. In one embodiment, the prequalification criteria may comprise at least one of a minimum income, minimum credit score, predefined prior eviction status, predefined allowable delinquent utility debt status, predefined allowable landlord debt collection status, move-in date, and predefined criminal conviction status. Of course, one skilled in the art will recognize that the foregoing are offered by way of example only and not of limitation. Some landlords and property managers may assign more or less prequalification criteria to various properties. Still, as some examples of prequalification criteria which may be provided to define eligibility for a certain property, minimum income may be set to two or three times the cost of rent, minimum credit score may be 650 points or above depending on standards set by various credit reporting bureaus, criminal history may lack any misdemeanor and felony convictions, and rental history may be clear of any evictions and landlord debt collections. Of course, various considerations may affect minimum income requirements without limitation, such as whether any roommates will be contributing to rent, as well as additional savings accounts, and even nontraditional income sources. Likewise, some landlords and property managers may have greater or lesser expectations relating to criminal conviction as well as eviction status. It should be understood that in practice, then, the prequalification criteria may comprise as many or as few eligibility requirements as desired, and to any extent desired, by a landlord or property manager. Thus, the foregoing are offered by way of example only and not of limitation.

In this exemplary embodiment, a server 120 may facilitate evaluation of a potential tenant's personal information against prequalification criteria among a limited group of members, as may be established by the members themselves. For the purpose of the example presented in FIG. 1, the limited group of members or parties, such as prospective tenants, landlords and even housing management companies, includes the users of electronic devices 102 and 104.

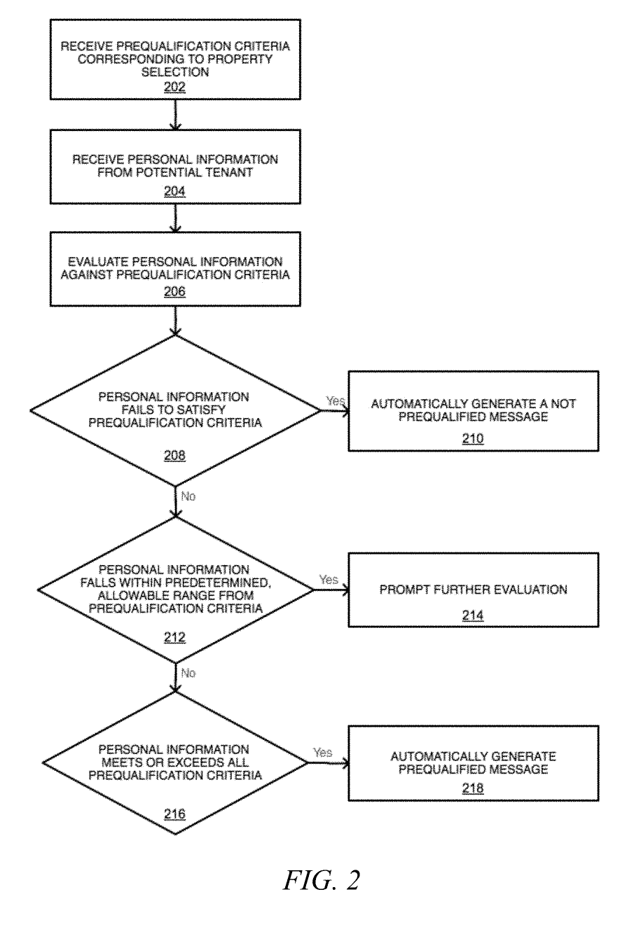

Additionally, server 120 implements the system for prescreening potential tenants and facilitates sharing evaluation of personal information provided by such potential tenants against landlord or property manager-provided prequalification criteria. Specifically, the server 120 implements the steps outlined in FIG. 2. Accordingly, a potential tenant, landlord, and/or real property manager can access the server 120 using their electronic devices 102 and 104 and can obtain information regarding one or more potential tenants' prequalification to apply to rent a given property.

In order to facilitate the aforementioned functionality, various aspects may be performed by one or more of the mobile devices 102, 104. In one embodiment, mobile device is operative to perform, at least in part, the method depicted in the flowchart of FIG. 2. Specifically, this method includes:

With respect to operation of system prescreening potential tenants 100, system 100 is operative to perform, at least in part, the method depicted in the flowchart of FIG. 2. Specifically, the method includes: receiving prequalification criteria (block 202) from a first party such as a landlord or even property manager; receiving personal information (block 202) corresponding to the same prequalification criteria from a second party such as a potential tenant; evaluating personal information received against the prequalification criteria (block 206); and responsive to determining that personal information fails to satisfy prequalification criteria (block 208), informing a potential tenant that they are unlikely to qualify by placing generating a message indicating that the potential tenant is not prequalified (block 210). In some embodiments, failure to satisfy prequalification criteria may occur when personal information deemed critical fails to meet threshold standards. Thus, as some non-limiting examples, one or more of a recent criminal conviction, previous eviction, and even evidence of delinquent utility debts may fail to satisfy prequalification criteria. It is contemplated that potential tenants receiving such messages may continue to file official rental applications, however, having received a message indicating a failure to prequalify, they may be reasonably sure that their application will be met with disapproval. In some embodiments, potential tenants who fail to prequalify may be placed on a waitlist so that any official rental applications submitted by them may be considered after other, more qualified applicants have turned down any opportunities to rent the property.

The method may further include: responsive to determining that personal information falls within a predetermined, allowable range from the prequalification criteria (block 212), prompting further evaluation (block 214) such as may uncover mitigating explanations. For example, in some embodiments, a potential tenant may have a monthly income that is slightly below the landlord or property manager's preferred minimum income. In such cases, the landlord or property manager may be prompted to request mitigating explanations, including for examples, proof of additional income, proof of guarantor, personal references, among others. In some instances, a potential tenant may have a credit score slightly below the landlord or property manager's preferred credit score, prompting them to request mitigating explanations for negative reports.

It is contemplated that the system will be operative to enable a potential tenant to affirmatively order their own credit report and score, thus avoiding the negative effect of a hard credit inquiry. In the event that a potential tenant's personal information fails to satisfy prequalification criteria, or that their persona information falls within a predetermined, allowable range from prequalification criteria, they may continue to seek prequalification to rent other properties with no fear that their credit will be negatively affected.

The method may even further include: responsive to determining that personal information meets or exceeds all prequalification criteria (block 216), generating a prequalified message (block 218) and even, in some embodiments, affirmatively inviting the prescreened tenant to submit a formal lease application to the landlord or property manager. In some embodiments, potential tenants whose personal information meets or exceeds all prequalification criteria may receive a notification of incentives to rent that they may enjoy upon officially applying to rent the related property. For instance, in some embodiments, the potential tenant's high credit score may qualify them for various move-in discounts and concessions, such as discounted rent and various waivers. Knowing this for certain, a potential applicant may be more inclined to accept the cost of a rental application.

If embodied in software, it should be noted that each block depicted in the accompanying flowcharts represents a module, segment, or portion of code that comprises program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system such as the mobile device 102 and 104. The machine code may be converted from the source code, etc. If embodied in hardware, each block may represent a circuit or a number of interconnected circuits to implement the specified logical function(s). Additionally, although the flowcharts show specific orders of execution, it is to be understood that the orders of execution may differ.

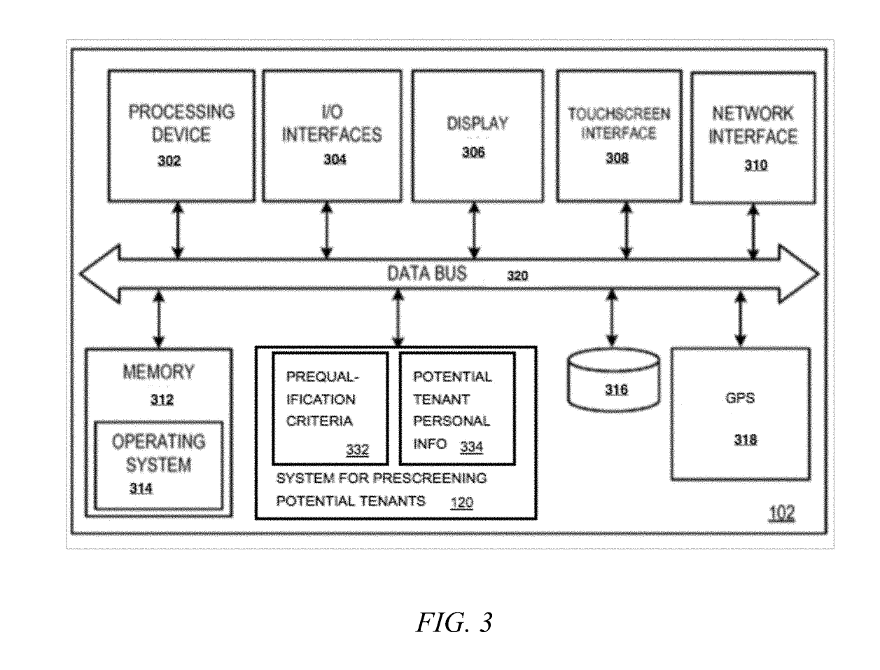

FIG. 3 illustrates one embodiment of electronic device 102 shown in FIG. 1. The electronic device 102 may be a desktop, laptop, or tablet computer or even smartphone but may also be embodied in any one of a wide variety of wired and/or wireless computing devices. As shown in FIG. 3, mobile device 102 comprises a processing device (processor) 302, input/output interfaces 304, a display 306, a touchscreen interface 308, a network interface 310, a memory 312, and operating system 314, a mass storage 316 and even a GPS 318, with each communicating across a local data bus 320. Additionally, the electronic device 102 incorporates an embodiment of the system for prescreening tenants 100, which is depicted as including, in relevant part, prequalification criteria 332 received from a first party such as a landlord or property manager, and personal information 334 received from one or more potential tenants, although the location of information 332 and 334 may vary.

The processing device 302 may include any custom made or commercially available processor, a central processing unit (CPU) or an auxiliary processor among several processors associated with the mobile device 102, a semiconductor based microprocessor (in the form of a microchip), a macroprocessor, one or more application specific integrated circuits (ASICs), a plurality of suitably configured digital logic gates, and other electrical configurations comprising discrete elements both individually and in various combinations to coordinate the overall operation of the system.

The memory 312 can include any one of a combination of volatile memory elements (e.g., random-access memory (RAM, such as DRAM, and SRAM, etc.)) and nonvolatile memory elements. The memory typically comprises native operating system 314, one or more native applications, emulation systems, or emulated applications for any of a variety of operating systems and/or emulated hardware platforms, emulated operating systems, etc. For example, the applications may include application specific software which may comprise some or all the components of the electronic device 102. In accordance with such embodiments, the components are stored in memory and executed by the processing device. Note that although depicted separately in FIG. 3, the system and method for prescreening potential tenants 100 may be resident in memory such as memory 312.

Touchscreen interface 308 is configured to detect contact within the display area of the display 306 and provides such functionality as on-screen buttons, menus, keyboards, etc. that allows users to navigate user interfaces by touch. For some embodiments, the electronic device 102 will comprise GPS 318 or other means to determine the location of the mobile device 102 which may be helpful for potential tenants considering applying to rent property available in a geographic region.

One of ordinary skill in the art will appreciate that the memory 314 can, and typically will, comprise other components which have been omitted for purposes of brevity. Note that in the context of this disclosure, a non-transitory computer-readable medium stores one or more programs for use by or in connection with an instruction execution system, apparatus, or device. With further reference to FIG. 3, network interface device 310 comprises various components used to transmit and/or receive data over a networked environment such as depicted in FIG. 1. When such components are embodied as an application, the one or more components may be stored on a non-transitory computer-readable medium and executed by the processing device.

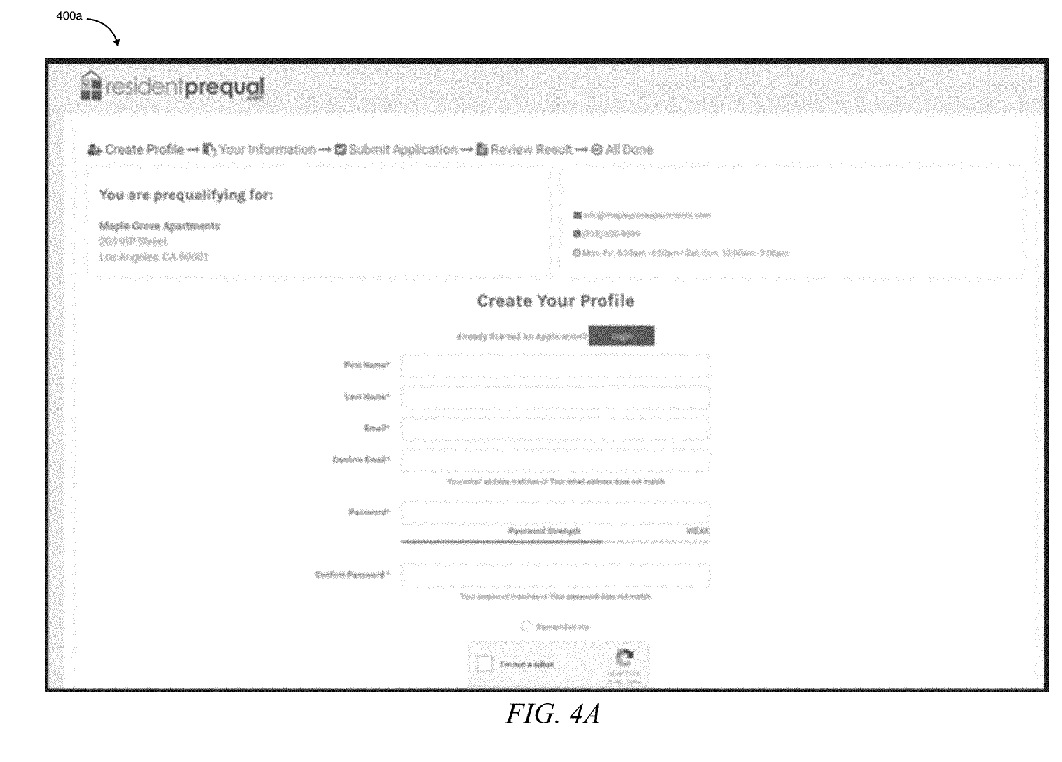

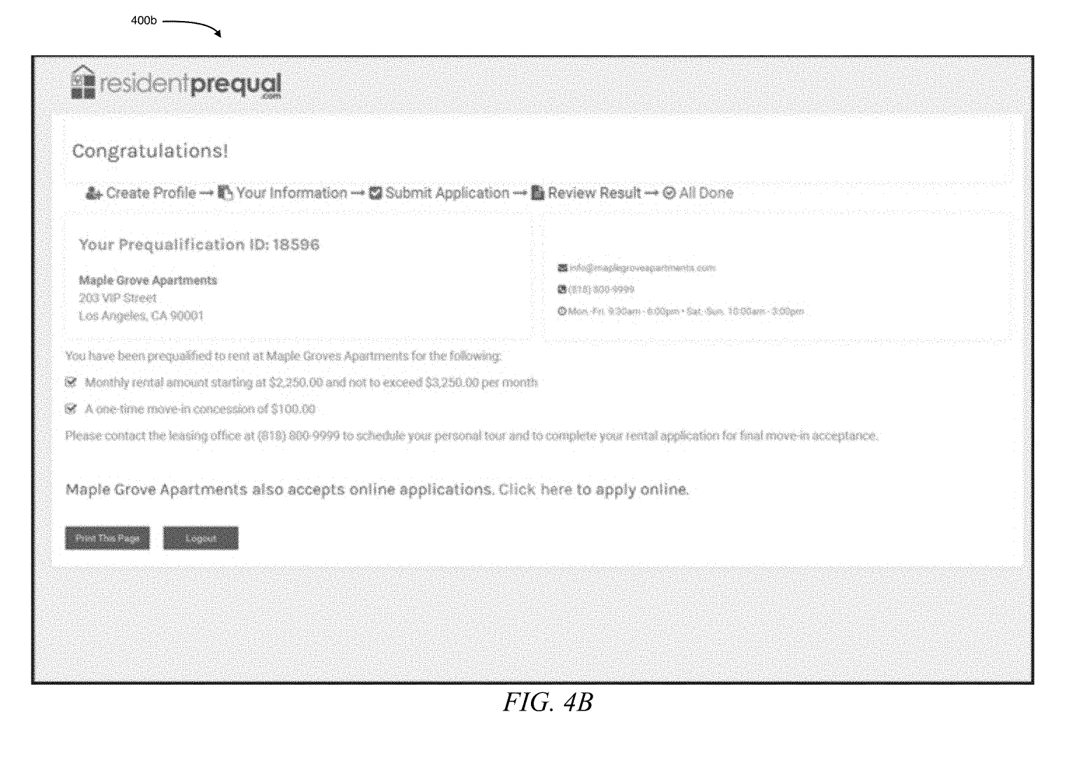

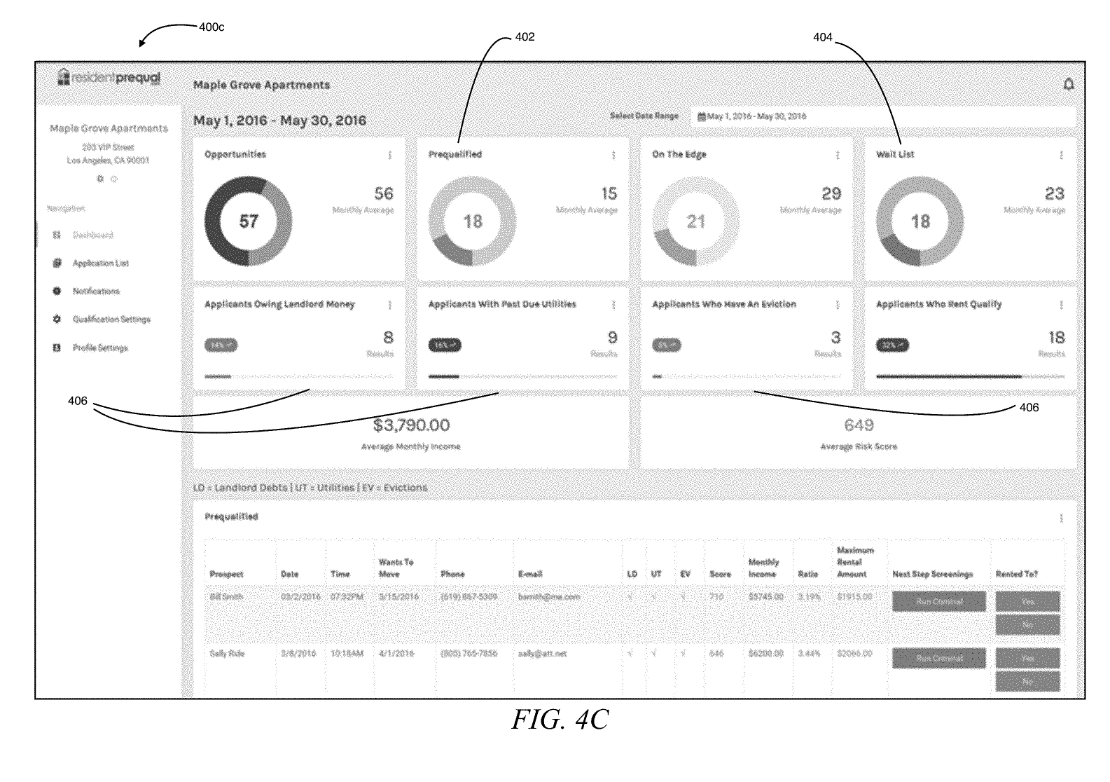

FIGS. 4A-C illustrates various embodiments of an exemplary user interface 400a, 400b, 400c for entering information associated the system and method for prescreening potential tenants. For instance, FIG. 4A illustrates one embodiment of a user interface 400a configured to identify potential tenant information. FIG. 4B illustrates one embodiment of a user interface 400b displaying an automatically generated prequalified message, as discussed with reference to FIG. 2 above. Finally, FIG. 4C illustrates an embodiment of a user interface 400c which may be accessed by a landlord or property manager to view data relating to prequalified 402 and not prequalified 404 potential tenants along with prompts for further investigating 406 other potential tenants. Of course, various embodiments of the user interface are possible and the figures are offered only as examples to enable the disclosure.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CONCLUSIONS, RAMIFICATIONS, AND SCOPE

While certain embodiments of the invention have been illustrated and described, various modifications are contemplated and can be made without departing from the spirit and scope of the invention. For example, the particular appearance of the user interface of the system for prescreening potential tenants may vary across electronic devices and even depending on whether such user has accessed the system as a landlord, property manager, or potential tenant. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the system, method, and apparatus for prescreening potential tenants with which that terminology is associated. In general, the terms used in the following claims should not be constructed to limit the system, method, and apparatus for prescreening potential tenants to the specific embodiments disclosed in the specification unless the above description section explicitly define such terms. Accordingly, the actual scope encompasses not only the disclosed embodiments, but also all equivalent ways of practicing or implementing the disclosed system, method and apparatus. The above description of embodiments of the system, method, and apparatus for prescreening potential tenants is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method and system disclosed are presented below in particular claim forms, various aspects of the method, system, and apparatus are contemplated in any number of claim forms. Thus, the inventor reserves the right to add additional claims after filing the application to pursue such additional claim forms for other aspects of the system, method, and apparatus for prescreening potential tenants.

What is claimed is:

1. A method for prescreening potential tenants, comprising:
receiving, at a first electronic device, one or more prequalification criteria from one of a landlord and property manager, the prequalification criteria defining eligibility requirements to rent a particular property;
receiving, at a second electronic device communicatively coupled with the first electronic device, personal information corresponding to the prequalification criteria from a potential tenant; and
evaluating personal information against prequalification criteria;
wherein, responsive to determining that personal information fails to satisfy prequalification criteria, automatically generating, at the first electronic device, a waitlist message viewable by the first and second parties;
wherein, responsive to determining that personal information falls within a predetermined allowable range below prequalification criteria, prompting, at the first electronic device, further evaluation by the first party; and
wherein, responsive to determining that personal information meets or exceeds all prequalification criteria, automatically generating, at the first electronic device, a prequalified message.

2. The method of claim 1, wherein the prequalification criteria comprise at least one of a minimum income, minimum credit score predefined delinquent utility debt status, predefined landlord debt collection status, predefined criminal conviction status, predefined prior eviction status, and move-in date.

3. The method of claim 2, wherein a potential tenant's credit score is obtained from a reporting bureau by the potential tenant him or herself.

4. The method of claim 1, wherein, further responsive to determining that personal information meets or exceeds all prequalification criteria, generating an invitation to apply to rent a property.

5. The method of claim 1, wherein further responsive to determining that personal information meets or exceeds all prequalification criteria, generating a notification of incentives to apply to rent property.

6. The method of claim 5, wherein incentives to apply to rent property comprise at least one of discounted rent, discounted security deposit, discounted application fee, waiver of first month's rent, and waiver of any application fee.

7. A system for prescreening potential tenants, comprising:
an electronic computing device operative to:
receive one or more prequalification criteria from one of a landlord and property manager, the prequalification criteria defining eligibility requirements to rent a particular property;
receive personal information corresponding to the prequalification criteria from a potential tenant; and
evaluating personal information against prequalification criteria;
wherein, responsive to determining that personal information fails to satisfy prequalification criteria, the electronic computer device is operative to automatically generate a waitlist message viewable by the first and second parties;
wherein, responsive to determining that personal information falls within a predetermined allowable range below prequalification criteria, the electronic computing device is operative to prompt further evaluation by the first party; and
wherein, responsive to determining that personal information meets or exceeds all prequalification criteria, the electronic computer device is operative to automatically generate a prequalified message.

8. The system of claim 7, wherein the prequalification criteria comprise at least one of a minimum income, minimum credit score, predefined delinquent utility debt status, predefined landlord debt collection status, predefined criminal conviction status, predefined prior eviction status, and move-in date.

9. The system of claim 8, wherein a potential tenant's credit score is obtained from a reporting bureau by the potential tenant him or herself.

10. The system of claim 7, wherein, further responsive to determining that personal information meets or exceeds all prequalification criteria, generating an invitation to apply to rent a property.

11. The system of claim 7, wherein further responsive to determining that personal information meets or exceeds all prequalification criteria, generating a notification of incentives to apply to rent property.

12. The system of claim 11, wherein incentives to apply to rent property comprise at least one of discounted rent, discounted security deposit, discounted application fee, waiver of first month's rent, and waiver of any application fee.

13. A non-transitory, tangible computer-readable medium having stored thereon computer-executable instructions, which, when executed by a computer processor, enable performance of the method comprising:
receiving, at a first mobile device, one or more prequalification criteria from a first party;
receive personal information corresponding to the prequalification criteria from a second party; and
evaluating personal information against prequalification criteria;
wherein, responsive to determining that personal information fails to satisfy prequalification criteria, automatically generating, the first electronic device, a waitlist message viewable by the first and second parties;
wherein, responsive to determining that personal information falls within a predetermined allowable range below prequalification criteria, prompting, at the first electronic device, further evaluation by the first party; and
wherein, responsive to determining that personal information meets or exceeds all prequalification criteria, automatically generating, at the first electronic device, a prequalified message.
